(19) United States
(12) Patent Application Publication
(10) Pub. No.: US 2024/0399846 A1
(43) Pub. Date: Dec. 5, 2024

(54) ENGINE-DRIVEN-DC-SUPPLY UNIT

(71) Applicant: YAMAHA HATSUDOKI KABUSHIKI KAISHA, Iwata-shi (JP)

(72) Inventors: Keisuke SHIOMI, Shizuoka (JP); Naoki KAWANO, Shizuoka (JP)

(21) Appl. No.: 18/807,635

(22) Filed: Aug. 16, 2024

Related U.S. Application Data
(63) Continuation-in-part of application No. PCT/JP2022/006595, filed on Feb. 18, 2022.

(51) Int. Cl. B60K 6/40; B60K 6/24; B60K 6/26; B60W 10/06; B60W 10/08; B60W 20/10

(52) U.S. Cl. CPC B60K 6/40; B60K 6/24; B60K 6/26; B60W 10/06; B60W 10/08; B60W 20/10

(57) ABSTRACT

An engine-driven-DC-supply unit, including: a main component supported by a base member; and a mount member connected to the base member and supporting an engine body and an electric generator of the main component through four elastic bodies. The engine-driven-DC-supply unit is configured to convert electric power generated by the electric generator driven by the engine body to DC power, and to supply the converted DC power to an external load device. The four elastic bodies are located at four points. A distance between any two of the four points located in a first direction, which is along an axis of a crankshaft of the engine body, is larger than a distance between any two of the four points located in a second direction that is orthogonal to the first direction. The four points surround a barycenter of the main component in a plan view.

### CROSS-REFERENCES TO RELATED APPLICATIONS

This is a continuation-in-part application of International Application No. PCT/JP2022/006595 filed on Feb. 18, 2022, the contents of which are incorporated herein by reference.

### TECHNICAL FIELD

The present teaching relates to an engine-driven-DC-supply unit.

### BACKGROUND ART

A range extender as an engine-driven-DC-supply unit is known. In this range extender, electric power generated by an electric generator driven by an engine is converted by a controller to direct current (DC) power, and a battery is charged with the DC power. As such an engine-driven-DC-supply unit, an activation generation unit disclosed in, for example, Patent Document 1 is known.

The activation generation unit is formed by arranging an engine and an electric generator horizontally and fixing the engine and the electric generator as one unit, and is supported by a vehicle through a plurality of mount bushes. The plurality of mount bushes support the engine at two points and support the electric generator at one point in a plan view.

As a structure in which an engine and an electric generator are supported by a plurality of mounts, a power-device-loading structure for a hybrid vehicle disclosed in Patent Document 2 is also known. In the power-device-loading structure disclosed in Patent Document 2, an electric-generator-mounted engine is supported to a mount frame at three points by mount rubber. Specifically, the electric-generator-mounted engine is supported through the mount rubber by posts projecting from front and rear portions of the mount frame, and a side surface of the electric generator of the electric-generator-mounted engine is supported through mount rubber by a post projecting on a side portion of the mount frame.

However, Patent Document 2 neither discloses nor suggests a barycenter of the electric-generator-mounted engine. Patent Document 2, of course, neither discloses nor suggests that the electric-generator-mounted engine is supported to surround the barycenter thereof in a plan view.

### CITATION LIST

### Patent Document

Patent Document 1: Japanese Patent Application Publication No. 2016-78622

Patent Document 2: Japanese Patent Application Publication No. H11-99834

### SUMMARY OF INVENTION

### Technical Problem

As described above, in an engine-driven-DC-supply unit proposed to date, the engine-driven-DC-supply unit is supported by a plurality of mount bushes or mount rubber so that vibrations transferred to a vehicle on which the engine-driven-DC-supply unit is mounted is thereby reduced.

To further enhance such vibration-transfer-reducing function, it is supposed to be effective to reduce support rigidity of the engine-driven-DC-supply unit, for example. However, when the support rigidity of the engine-driven-DC-supply unit is reduced, the posture of the engine-driven-DC-supply unit might be easily changed.

To address this, there has been a demand for a support structure capable of further enhancing the vibration-transfer-reducing function of reducing transfer of vibrations generated in the engine-driven-DC-supply unit to the outside while suppressing a posture change of the engine-driven-DC-supply unit.

It is therefore an object of the present teaching to provide an engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit.

### Solution to Problem

The inventors of the present teaching studied a configuration of an engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit. Through an intensive study, the inventors arrived at the following configuration.

An engine-driven-DC-supply unit according to one embodiment of the present teaching includes: a base member; a main component including an engine unit including an engine body having a crankshaft, an electric generator unit including an electric generator that is driven by the engine body, and a controller that controls the engine unit and the electric generator unit, the main component being supported by the base member; and a mount member and four elastic bodies, the mount member being connected to the base member and supporting the engine body and the electric generator through the four elastic bodies, wherein the engine-driven-DC-supply unit is configured to convert electric power generated by the electric generator driven by the engine body to DC power, and to supply the converted DC power to an external load device, without providing mechanical traveling power to the external load device. The four elastic bodies are located at four points, where a distance between any two of the four points located in a first direction, which is along an axis of the crankshaft of the engine body, is larger than a distance between any two of the four points located in a second direction, which is orthogonal to the first direction, and the four points surround a barycenter of the main component in a plan view of the engine-driven-DC-supply unit.

With this configuration, the engine body and the electric generator are supported by the mount member through the elastic bodies at four points with a posture change further suppressed by the mount member such that the distance between two points located in the axial direction along the axis of the crankshaft of the engine body is larger than the distance between two points located in the direction orthogonal to the axial direction and that the four points surround the barycenter of the main component in the plan view.

Thus, since the elastic bodies support the engine body and the electric generator at the four points such that the distance between two points located in the axial direction is larger than the distance between two points located in the direction orthogonal to the axial direction in the plan view, support rigidity of the plurality of elastic bodies in the direction orthogonal to the axial direction is smaller than the support rigidity in the axial direction. Thus, the elastic bodies easily deform around the axis of the crankshaft. Accordingly, it is possible to effectively reduce transfer of vibrations of the main component generated in a direction around the axis of the crankshaft to the base member.

As a result, it is possible to obtain the engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit.

In another aspect, an engine-driven-DC-supply unit according to the present teaching preferably includes the following configuration. In the plan view, two of the four points are positioned at each side of the barycenter in the first direction, and two of the four points are positioned at each side of the barycenter in the second direction.

With this configuration, the engine body and the electric generator are supported by the mount member through the elastic bodies at the four points surrounding the barycenter of the main component in a plan view. Thus, the engine body and the electric generator can be more reliably supported, and transfer of vibrations of the main component to the base member can be effectively reduced.

As a result, it is possible to obtain the engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit.

In another aspect, an engine-driven-DC-supply unit according to the present teaching preferably includes the following configuration. The mount member supports the engine body and the electric generator through the elastic bodies at a plurality of positions at at least one of one side or the other side of the barycenter in the first direction in the plan view.

With this configuration, the engine body and the electric generator are supported by the mount member through the elastic bodies at a plurality of positions at at least one of one side or the other side of the barycenter in the axial direction in the plan view. Thus, the engine body and the electric generator can be more reliably supported, and transfer of vibrations of the main component to the base member can be effectively reduced.

As a result, it is possible to obtain the engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit.

In another aspect, an engine-driven-DC-supply unit according to the present teaching preferably includes the following configuration. Each of the elastic bodies is a metal spring.

In a case where each of the elastic bodies is easily deformed with a large stroke, vibrations generated in the main component are less likely to be transferred to the base member. In the case where each of the elastic bodies is a spring as described in the above configuration, the elastic body is easily deformed so that a stroke occurring in the deformation of the elastic body can be increased. In addition, the elastic body of the metal spring can increase a stroke in deformation as described above while supporting a heavy object such as the main component.

As a result, it is possible to obtain the engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit.

In another aspect, an engine-driven-DC-supply unit according to the present teaching preferably includes the following configuration. The engine-driven-DC-supply unit further includes a stopper that restricts movement of the main component with respect to the base member to within a predetermined range.

This configuration can reduce significant displacement of the main component supported by the mount member with respect to the base member due to deformation of the elastic bodies caused by vibrations of the main component. Thus, it is possible to reduce contact of the main component with the base member and displacement of the main component to the outside of the base member.

In another aspect, an engine-driven-DC-supply unit according to the present teaching preferably includes the following configuration. Each of the elastic bodies is located between the base member and the mount member, and expansion and contraction of said each elastic body is in a vertical direction.

With this configuration, a force including a load of the mount member is input to the elastic bodies in the expansion and contraction direction so that the elastic bodies are thereby easily deformed in the expansion and contraction direction. As a result, transfer of vibrations of the main component to the base member from the mount member can be effectively reduced.

In another aspect, an engine-driven-DC-supply unit according to the present teaching preferably includes the following configuration. Each of the elastic bodies is a tension spring.

In a case where each of the elastic bodies is a compression spring, buckling might occur by a force input from the mount member to the base member. In addition, in the case where each of the elastic bodies is a compression spring, a member for preventing buckling of the compression spring is needed.

On the other hand, in the configuration in which each of the elastic bodies is a tension spring, the elastic body is easily deformed in the expansion and contraction direction by a force input from the mount member to the base member. Thus, a stroke in the elastic body in the expansion and contraction direction can be increased. Accordingly, transfer of vibrations of the main component to the base member from the mount member can be effectively reduced. In addition, since each of the elastic bodies is a tension spring, a member for preventing buckling is unnecessary, unlike the case of a compression spring. As a result, the lightweight engine-driven-DC-supply unit can be obtained at low costs.

In another aspect, an engine-driven-DC-supply unit according to the present teaching preferably includes the following configuration. The mount member is configured such that at least a part of the mount member is located outward of the main component in the plan view and a bottom view of the engine-driven-DC-supply unit, and each of the elastic bodies is located between an uppermost end and a lowermost end of the main component in a top-bottom direction.

With this configuration, the main component including the engine unit, the electric generator unit, and the controller can be supported by the elastic bodies between the uppermost end and the lowermost end at sides thereof. Accordingly, since the elastic bodies can be located close to the barycenter of the main component in the top-bottom direction so that a stroke occurring in deformation of the elastic bodies can be thereby reduced. Thus, the elastic bodies can be configured to elastically deform easily. As a result, it is possible to further ensure reduction of transfer of vibrations occurring in the main component to the base member through the elastic bodies.

In addition, since the main component is supported by the mount member at the sides thereof, layout flexibility of constituents of the main component can be increased, and design flexibility of the shape of the base member supporting the main component can be increased. As a result, the main component is concentrated to be compactly placed.

In another aspect, an engine-driven-DC-supply unit according to the present teaching preferably includes the following configuration. Each of the elastic bodies is located within three regions close to a center in the top-bottom direction in five regions obtained by equally dividing a region between the uppermost end and the lowermost end of the main component in the top-bottom direction.

With this configuration, since each of the elastic bodies can be located closer to the barycenter of the main component in the top-bottom direction, and thus, a stroke occurring in deformation of the elastic body can be reduced. Thus, the elastic bodies can be configured to elastically deform easily. As a result, it is possible to further ensure reduction of transfer of vibrations occurring in the main component to the base member through the elastic bodies.

In addition, the above-described arrangement of the elastic bodies can increase layout flexibility of constituents of the main component.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of an engine-driven-DC-supply unit according to the present teaching will be herein described.

In the following description, numerous specific details are set forth in order to provide a thorough understanding of the present invention. It is obvious that those skilled in the art, however, would be able to carry out the present invention without these specific examples.

The present disclosure is to be considered as an exemplification of the invention, and is not intended to limit the invention to the specific embodiments illustrated by the figures or description below.

### Engine-Driven-DC-Supply Unit

An engine-driven-DC-supply unit herein is a unit that includes: an engine unit including an engine body; an electric generator unit including an electric generator; and a controller, converts electric power output from the electric generator driven by the engine body to DC power by the controller, and outputs the converted DC power. That is, the engine-driven-DC-supply unit is a unit without providing mechanical power to an external load device. The engine-driven-DC-supply unit is mountable or detachable to/from the external load device. The engine-driven-DC-supply unit may be used as a power generating unit that outputs DC power while being placed on a base, the ground, or other places, without being mounted on the external load device.

### Main Component

A main component herein refers to main constituents of an engine-driven-DC-supply unit that include an engine unit that includes an engine body, an electric generator unit including an electric generator, and a controller that controls the engine unit and the electric generator unit. The main component is supported by a base member. The main component may include constituents other than the engine unit, the electric generator unit, and the controller.

### Engine Unit

An engine unit herein includes intake-system constituents such as an engine body, an intake pipe, and an air filter, and exhaust-system constituents such as an exhaust pipe and an exhaust-gas-purifying device. The engine unit is without a fuel tank.

### Electric Generator Unit

An electric generator unit herein includes an electric generator, a fan, a cover, and so forth.

### External Load Device

An external load device herein refers to a device that receives DC power without receiving mechanical power, from the engine-driven-DC-supply unit. The external load device includes an electric power storage, a driving load, and so forth.

### Outside, External

The terms “outside” and “external” refer to a region other than the engine-driven-DC-supply unit. The “outside” or “external” includes, for example, a structure on which the engine-driven-DC-supply unit can be placed, such as a mobile object, ground, or a base.

### Elastic Body

An elastic body herein refers to a member that supports a main component and is elastically deformable in accordance with vibrations of the main component and a posture change of a mobile object, for example. The elastic body may be, for example, a spring such as a tension spring or a compression spring or a member made of an elastic material such as rubber or resin.

### Advantageous Effects of Invention

One embodiment of the present teaching can provide an engine-driven-DC-supply unit capable of further enhancing vibration-transfer-reducing function of reducing transfer of vibrations generated in the engine-driven-DC-supply unit to the outside while suppressing a posture change of the engine-driven-DC-supply unit.

### BRIEF DESCRIPTION OF DRAWINGS

FIG. 1 is a side view illustrating a schematic configuration of an engine-driven-DC-supply unit according to a first embodiment.

FIG. 2A is a side view of the engine-driven-DC-supply unit when the engine-driven-DC-supply unit is seen in an axial direction.

FIG. 2B is a bottom view illustrating a schematic configuration of the engine-driven-DC-supply unit.

FIG. 3 is a side view of the engine-driven-DC-supply unit when the engine-driven-DC-supply unit is seen in a direction orthogonal to the axial direction.

FIG. 4 is a plan view illustrating a schematic configuration of the engine-driven-DC-supply unit according to the first embodiment.

FIG. 5 is a side view illustrating a state where the engine-driven-DC-supply unit according to the first embodiment is mounted on a vehicle.

FIG. 6 is a side view illustrating a state where the engine-driven-DC-supply unit according to the first embodiment is placed on, for example, the ground.

FIGS. 7A, 7B and 7C are plan views schematically illustrating layout examples of elastic bodies supporting a main component of the engine-driven-DC-supply unit.

FIG. 8 is a side view of an engine-driven-DC-supply unit according to a third embodiment when the engine-driven-DC-supply unit is seen in a direction orthogonal to an axial direction.

FIG. 9 is an enlarged view illustrating a connection portion where elastic bodies are connected to a base member and a pair of mount members in an engine-driven-DC-supply unit according to a fourth embodiment.

FIG. 10 is a side view of an engine-driven-DC-supply unit according to a fifth embodiment when the engine-driven-DC-supply unit is seen in an axial direction.

FIG. 11 is a side view of the engine-driven-DC-supply unit according to the fifth embodiment when the engine-driven-DC-supply unit is seen in a direction orthogonal to the axial direction.

### DESCRIPTION OF EMBODIMENTS

Embodiments will be described hereinafter with reference to the drawings. In the drawings, the same or corresponding parts are denoted by the same reference numerals, and description thereof will not be repeated. The dimensions of components in the drawings do not strictly represent actual dimensions of the components and dimensional proportions of the components.

In the following description, a top-bottom direction of an engine-driven-DC-supply unit 1 refers to a top-bottom direction in a state where mount members 61 and 62 support a main component 50 from below. Layout of the engine-driven-DC-supply unit 1 may have a layout other than the above-described layout. Specifically, the top-bottom direction of the engine-driven-DC-supply unit 1 is not limited to the direction described above.

In the following description, the axial direction refers to a direction in which a crankshaft of an engine body 11 and a rotation axis of an electric generator 21 extend. A radial direction refers to a radial direction of the electric generator 21. A circumferential direction refers to a rotational direction of the electric generator 21.

### First Embodiment

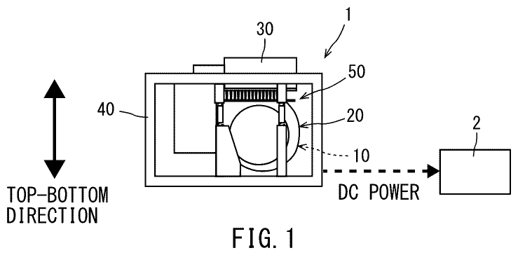

FIG. 1 is a side view illustrating a schematic configuration of an engine-driven-DC-supply unit 1.

The engine-driven-DC-supply unit 1 supplies electric power to an external load device 2. The engine-driven-DC-supply unit 1 is without supplying mechanical power to the external load device 2.

The external load device 2 includes, for example, an electric power storage or an electrical load. The external load device 2 is, for example, a device including the electric power storage or the electrical load, and may be a mobile object or an immovable fixed device. The electric power storage is a battery or a capacitor, for example. The electrical load is a motor, an illumination device, or an electric equipment, for example. The engine-driven-DC-supply unit 1 supplies DC power to the electric power storage or the electrical load included in the external load device 2.

The engine-driven-DC-supply unit 1 includes a base member 40 and a main component 50. The main component 50 is elastically supported to the base member 40.

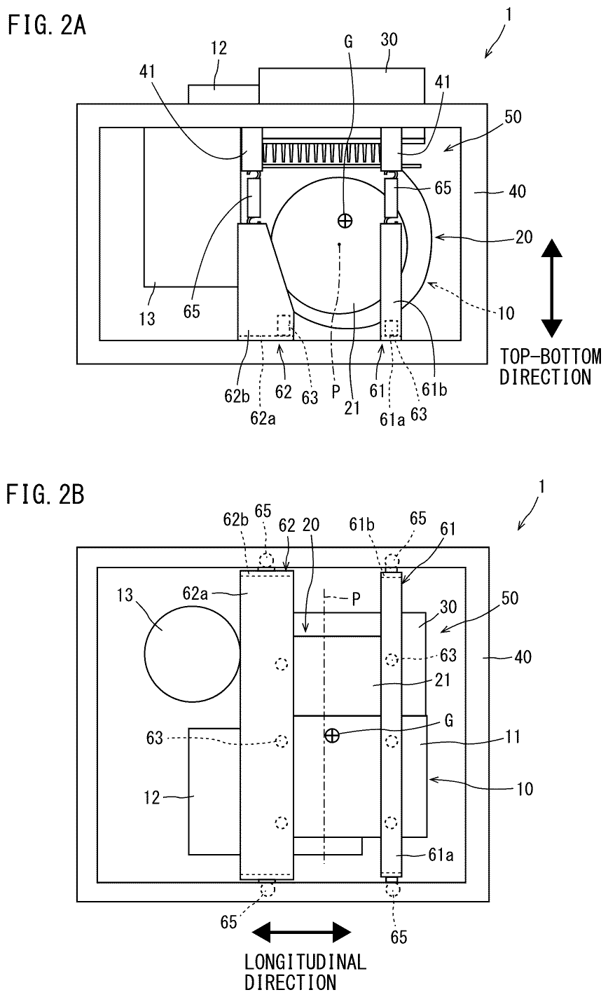

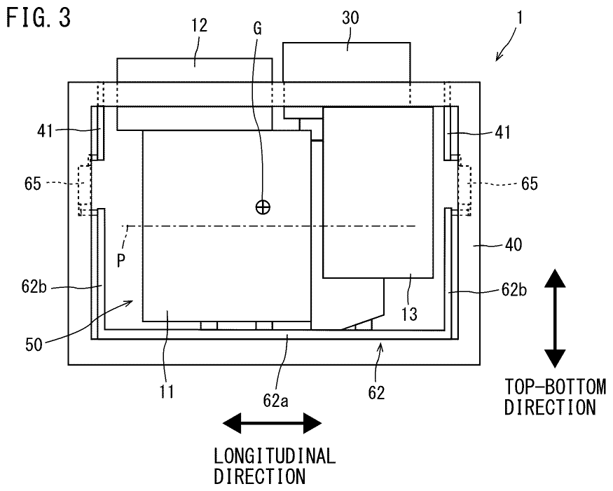

FIG. 2A is a side view of the engine-driven-DC-supply unit 1 when the engine-driven-DC-supply unit 1 is seen in the axial direction. FIG. 2B is a bottom view illustrating a schematic configuration of the engine-driven-DC-supply unit 1. FIG. 3 is a side view of the engine-driven-DC-supply unit 1 when the engine-driven-DC-supply unit 1 is seen in a direction orthogonal to the axial direction.

As illustrated in FIGS. 1, 2A, 2B, and 3, the base member 40 is a rectangular parallelepiped frame constituted by a plurality of beam members. The main component 50 can be compactly placed in the base member 40.

The base member may be a frame having another shape. The base member may be a structure constituted by faces such as a box shape, rather than the frame. The base member may be constituted by plate members, for example.

The main component 50 includes an engine unit 10, an electric generator unit 20, and a controller 30. That is, the engine-driven-DC-supply unit 1 includes the engine unit 10, the electric generator unit 20, the controller 30, and the base member 40. The engine-driven-DC-supply unit 1 converts electric power generated by the electric generator unit 20 driven by the engine unit 10 to DC power by the controller 30, and outputs the converted DC power.

In this embodiment, the main component 50 refers to main constituents of the engine-driven-DC-supply unit 1 including the engine unit 10, the electric generator unit 20, and the controller 30 that controls the engine unit 10 and the electric generator unit 20. The main component 50 is supported by the base member 40. The main component 50 may include constituents other than the engine unit 10, the electric generator unit 20, and the controller 30.

The engine unit 10 includes an engine body 11 that rotates an unillustrated crankshaft. The engine unit 10 may include an intake pipe, an air cleaner 12, an exhaust pipe, an exhaust-gas-processing device 13, and so forth, as well as the engine body 11. The engine unit 10 is without a fuel tank. The crankshaft rotates about an axis P. Although not particularly shown, the crankshaft is connected to a rotation shaft for rotating a rotor of an electric generator 21 described later,

The electric generator unit 20 includes the electric generator 21. The electric generator unit 20 may include a fan, a terminal, a cover, and so forth, as well as the electric generator 21. The electric generator 21 includes a stator and a rotor. The rotor is fixed to the rotation shaft connected to the crankshaft of the engine body 11. Accordingly, the rotor rotates together with the crankshaft of the engine body 11 and the rotation shaft. The electric generator 21 is located in the axial direction of the crankshaft with respect to the engine body 11. The electric generator 21 outputs electric power generated by rotation of the rotor as described above. The configuration of the electric generator 21 will not be described in detail.

The controller 30 controls the engine unit 10 and the electric generator unit 20, and converts electric power generated by the electric generator 21 driven by the engine body 11 to DC power. That is, the controller 30 has functions as an engine controller, an electric-generator controller, and an electric power converter. The controller 30 is housed in a casing.

The controller 30 may include only a part of the functions as the engine controller, the electric-generator controller, and the electric power converter. A part of the engine controller, the electric-generator controller, and the electric power converter may be obtained by another device of the engine-driven-DC-supply unit 1 or a device outside the engine-driven-DC-supply unit 1. The controller 30 may be constituted by a plurality of controllers or by one controller.

The main component 50 is supported by the base member 40 through a pair of mount members 61 and 62 and elastic bodies 65. Each of the pair of mount members 61 and 62 is constituted by a plate-shaped member that is bent in a U shape. The pair of mount members 61 and 62 is positioned in a long-side direction of the rectangular parallelepiped base member 40, and is parallel with each other.

The mount member 61 includes a bottom 61a and a pair of connection portions 61b. The bottom 61a extends in parallel with the axis P of the crankshaft below the main component 50. The pair of connection portions 61b extends upward from the ends of the bottom 61a in the axial direction. The bottom 61a and the pair of connection portions 61b are formed as one unit. The bottom 61a and the pair of connection portions 61b may be formed as separate members and connected to each other.

The mount member 62 includes a bottom 62a and a pair of connection portions 62b. The configuration of the mount member 62 is similar to that of the mount member 61 and thus will not be described in detail. In this embodiment, a dimension of the mount member 62 in a direction orthogonal to the axis P (hereinafter referred to as a width) is larger than a width of the mount member 61. Alternatively, the widths of the mount members 61 and 62 may be the same, or the width of the mount member 62 may be smaller than the width of the mount member 61.

Ends of the connection portions 61b and 62b of the pair of mount members 61 and 62 are connected to supporters 41 fixed to the base member 40 through the elastic bodies 65. The elastic bodies 65 are preferably metal springs extendable in one direction, for example.

In a case where the elastic bodies 65 are easily deformed with a large stroke, vibrations generated in the main component 50 are less likely to be transferred to the base member 40. In the case where the plurality of elastic bodies 65 are springs as described in the above configuration, the elastic bodies 65 are easily deformed, and a stroke occurring in the deformation of the elastic bodies 65 can be increased. In addition, the elastic bodies 65 of metal springs can increase a stroke occurring in the deformation of the elastic bodies 65 while supporting a heavy object such as the main component 50.

As a result, it is possible to obtain the engine-driven-DC-supply unit 1 capable of further enhancing vibration-transfer-reducing function of reducing transfer of vibrations generated in the engine-driven-DC-supply unit to the outside while suppressing a posture change of the engine-driven-DC-supply unit 1.

As described above, with the configuration in which the elastic bodies 65 are easily deformed, vibrations at a predetermined frequency or higher in vibrations generated in the main component 50 are not transferred to the base member 40 through the elastic bodies 65. Vibrations of the main component 50 that can be absorbed by the elastic bodies 65 may be either vibrations caused by rotational motion or vibrations caused by translational motion.

The elastic bodies 65 are preferably tension springs. In a case where the elastic bodies 65 are compression springs, for example, buckling might occur by a force input from the pair of mount members 61 and 62 to the base member 40. On the other hand, since the elastic bodies 65 are tension springs as described in this embodiment, the force input from the pair of mount members 61 and 62 to the base member 40 causes the elastic bodies 65 to be deformed easily in the expansion and contraction direction. Accordingly, transfer of vibrations of the main component 50 to the base member 40 from the pair of mount members 61 and 62 can be effectively reduced. In addition, since the elastic bodies 65 are tension springs, it is unnecessary for the engine-driven-DC-supply unit 1 to include a member for preventing buckling, unlike the case of compression springs. Accordingly, the lightweight engine-driven-DC-supply unit 1 can be obtained at low costs.

The elastic bodies may have a structure other than tension springs, such as compression springs and rubber, as long as the elastic bodies can be elastically deformed to reduce transfer of vibrations from the pair of mount members 61 and 62 to the base member 40. The elastic bodies may be made of other materials such as resin.

Ends at one side (lower ends) of the elastic bodies 65 are connected to ends of the connection portions 61b and 62b in the pair of mount members 61 and 62. Ends at the other side (upper ends) of the elastic bodies 65 are connected to the supporters 41 fixed to the base member 40.

Thus, each of the pair of mount members 61 and 62 is elastically supported to the base member 40 through the elastic body 65 at two points. Accordingly, the main component 50 supported by the pair of mount members 61 and 62 is elastically supported to the base member 40 through the pair of mount members 61 and 62 and the elastic bodies 65 at four points.

The elastic bodies 65 are located between the base member 40 and the pair of mount members 61 and 62 such that the expansion and contraction direction of the elastic bodies 65 is the vertical direction.

Accordingly, a force including loads of the pair of mount members 61 and 62 is input to the elastic bodies 65 in the expansion and contraction direction so that the elastic bodies 65 are thereby easily deformed in the expansion and contraction direction. As a result, transfer of vibrations of the main component 50 to the base member 40 from the pair of mount members 61 and 62 can be effectively reduced.

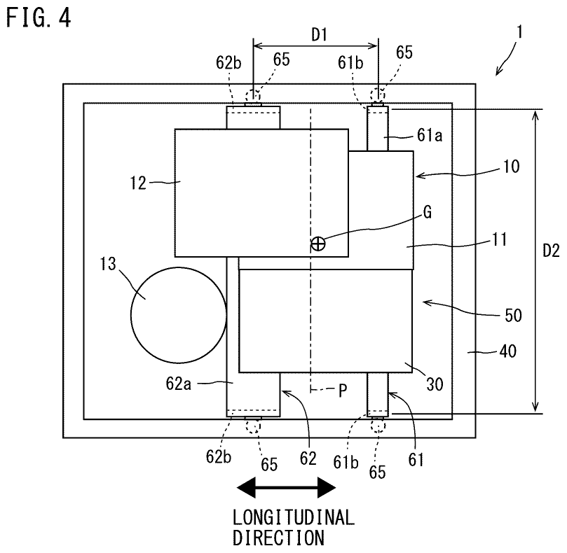

FIG. 4 is a plan view illustrating a schematic configuration of the engine-driven-DC-supply unit 1. As illustrated in FIG. 4, the four elastic bodies 65 are arranged to surround a barycenter G of the main component 50 in a plan view.

As illustrated in FIG. 4, the pair of mount members 61 and 62 is arranged such that the elastic bodies 65 are located at four points surrounding the barycenter G of the main component 50 in a plan view. Accordingly, the main component 50 is elastically supported by the base member 40 through the elastic bodies 65 at the four points surrounding the barycenter G of the main component 50 in a plan view of the engine-driven-DC-supply unit 1. In addition, as illustrated in FIG. 4, among the four points, the distance between two points located in the axial direction along the axis P of the crankshaft of the engine body 11 is larger than the distance between two points located in a direction orthogonal to the axial direction.

The expression “the elastic bodies 65 are located at four points surrounding the barycenter G of the main component 50 in a plan view” herein means that the barycenter G of the main component 50 is located within a region surrounded by the four elastic bodies 65 when the engine-driven-DC-supply unit 1 is seen in a plan view. In this embodiment, when the engine-driven-DC-supply unit 1 is seen in a plan view, the barycenter G of the main component 50 is located within a region of a quadrangle (e.g., rectangle) whose vertexes respectively coincide with the four elastic bodies 65. The four elastic bodies 65 may be located to form a parallelogram or trapezoid, for example, or other quadrangles, when the engine-driven-DC-supply unit 1 is seen in a plan view. In this case, characteristics (e.g., elastic modulus) of the four elastic bodies 65 may be individually changed depending on the positions of the four elastic bodies 65 such that transfer of vibrations of the main component 50 can be reduced.

When the engine-driven-DC-supply unit 1 is seen in a plan view, the positions of the four points include a position at one side of the barycenter G of the main component 50 in the axial direction, a position at the other side of the barycenter G in the axial direction, a position at one side of the barycenter G in a direction orthogonal to the axial direction, and a position at the other side of the barycenter G in the direction orthogonal to the axial direction, for example.

The configuration described above further ensures support of the main component 50 to the base member 40 at the four points. Specifically, the engine body 11 and the electric generator 21 are supported by the pair of mount members 61 and 62 with a posture change further suppressed at the four points surrounding the barycenter G of the main component 50 through the elastic bodies 65 arranged in the axial direction along the axis P of the crankshaft of the engine body 11 and in the direction orthogonal to the axial direction in a plan view. Thus, transfer of vibrations from the engine-driven-DC-supply unit 1 to the outside can be reduced. Accordingly, in the case of placing the engine-driven-DC-supply unit 1 on the base, it is unnecessary for the base to have high rigidity enough to endure large vibrations.

In this embodiment, the elastic bodies 65 are arranged in the axial direction along the axis P of the crankshaft of the engine body 11 and in the direction (identical to the axial direction in this embodiment) orthogonal to the axial direction. That is, the pair of mount members 61 and 62 supports the engine body 11 and the electric generator 21 to the base member 40 through the elastic bodies 65 arranged in the axial direction along the axis P of the crankshaft of the engine body 11 and in the direction orthogonal to the axial direction.

In this embodiment, for example, the pair of mount members 61 and 62 may support the engine body 11 and the electric generator 21 through the elastic bodies 65 at a plurality of positions at at least one side of the barycenter of the main component 50 in the axial direction, in a plan view. This further ensures support of the engine body 11 and the electric generator 21. The pair of mount members 61 and 62 may support the engine body 11 and the electric generator 21 through the elastic bodies 65 at one point at at least one side of the barycenter of the main component 50 in the axial direction in a plan view.

As illustrated in FIG. 4, the elastic bodies 65 are arranged such that a distance D2 between two points located in the axial direction is larger than a distance D1 between two points located in the direction orthogonal to the axial direction in a plan view of the engine-driven-DC-supply unit 1. In the elastic bodies 65, the distance D2 in the axial direction means a minimum distance among distances between center points of the elastic bodies 65 arranged in the axial direction. The distance D1 in the direction orthogonal to the axial direction means a minimum distance among distances between center points of the elastic bodies 65 arranged in the direction orthogonal to the axial direction.

Accordingly, in the elastic bodies 65, support rigidity in the direction orthogonal to the axial direction is smaller than support rigidity in the axial direction. Thus, the elastic bodies 65 are easily deformed around the axis P of the crankshaft. As a result, the elastic bodies 65 can easily absorb displacement occurring in a direction around the axis P of the crankshaft. Thus, it is possible to effectively reduce transfer of vibrations of the main component 50 occurring in the direction around the axis P of the crankshaft to the base member 40.

As a result, it is possible to obtain the engine-driven-DC-supply unit 1 capable of further enhancing vibration-transfer-reducing function of reducing transfer of vibrations generated in the engine-driven-DC-supply unit to the outside while suppressing a posture change of the engine-driven-DC-supply unit 1.

As illustrated in FIG. 2B, at least a part of the pair of mount members 61 and 62 may be located outward of the main component 50 in a plan view and a bottom view. The main component 50 may be supported by the pair of mount members 61 and 62 at end portions of the main component 50 in the long-side direction of the rectangular parallelepiped base member 40. As illustrated in FIG. 3, the pair of mount members 61 and 62 may be configured such that the elastic bodies 65 are located between the upper end and the lower end of the main component 50 in the top-bottom direction.

Accordingly, the main component 50 is supported by the elastic bodies 65 at side portions between the upper end and lower end of the main component 50. In this manner, since the elastic bodies 65 can be located close to the barycenter G of the main component 50 in the top-bottom direction so that a stroke occurring in deformation of the elastic bodies 65 can be reduced. Accordingly, the elastic bodies 65 can be configured to elastically deform easily. As a result, it is possible to further ensure reduction of transfer of vibrations occurring in the main component 50 to the base member 40 through the elastic bodies 65.

In addition, the main component 50 is supported by the pair of mount members 61 and 62 at the sides thereof. Accordingly, layout flexibility of constituents of the main component 50 can be increased, and design flexibility of the shape of the base member 40 supporting the main component 50 can be increased. As a result, the main component 50 is concentrated to be compactly placed.

In the manner described above, the pair of mount members 61 and 62 can increase layout flexibility of constituents in the engine-driven-DC-supply unit 1 and design flexibility of the shape of the base member 40, while reducing transfer of vibrations occurring in the engine-driven-DC-supply unit 1 to the outside. Accordingly, versatility of the engine-driven-DC-supply unit 1 can be enhanced.

In the main component 50, the engine body 11 and the electric generator 21 are supported by a plurality of top-bottom-direction supporters 63 located on the bottoms 61a and 62a of the pair of mount members 61 and 62. Accordingly, the positions of the engine body 11 and the electric generator 21 in the top-bottom direction can be adjusted.

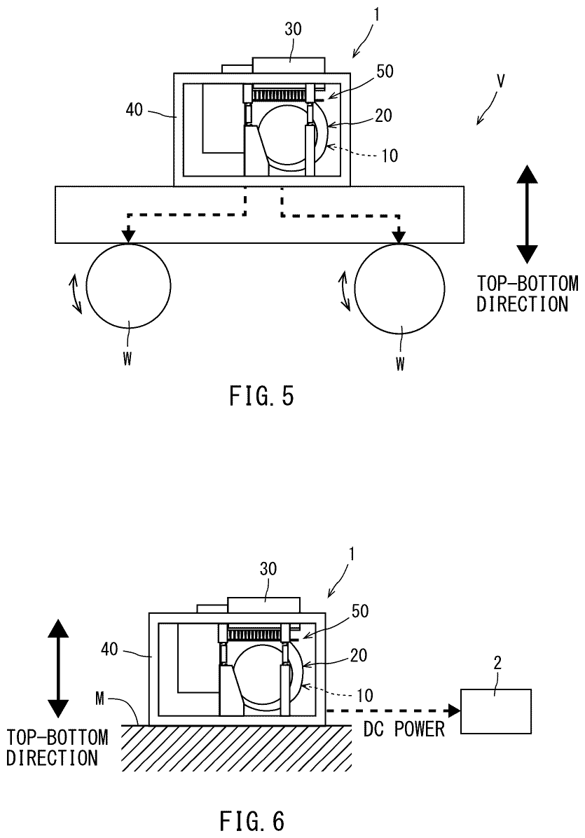

FIG. 5 is a side view schematically illustrating a case where the engine-driven-DC-supply unit 1 is mounted on a mobile object (vehicle V) that is an example of the external load device. FIG. 6 is a side view schematically illustrating a state where the engine-driven-DC-supply unit 1 placed on the ground M supplies electric power to the external load device 2 (e.g., battery). As illustrated in FIGS. 5 and 6, the engine-driven-DC-supply unit 1 may be mounted on the mobile object (vehicle V) or may be placed on the ground M. The engine-driven-DC-supply unit 1 may be attached to the mobile body or a fixed device or may be placed on the ground M, a base, another device, or the like without being attached to another device, as long as the engine-driven-DC-supply unit 1 can supply DC power to the external load device 2.

The engine-driven-DC-supply unit 1 may charge a battery of a mobile object, for example. The battery of the mobile object may be detachable from the mobile object or may be fixed to the mobile object. The engine-driven-DC-supply unit 1 may charge a battery of an electric tool, an electric work machine, or the like, for example. The engine-driven-DC-supply unit 1 may supply electric power to an illumination device or other devices, for example. The engine-driven-DC-supply unit 1 may supply electric power to a driving source such as a motor of a pump or a motor of a compressor, for example.

The mobile object refers to an object that is movable by power, such as a vehicle, an aircraft, or a ship. The mobile object includes vehicles. The mobile object is provided with a power unit (e.g., motor) that generates power by energy supplied from an energy source. Examples of the energy source include the engine-driven-DC-supply unit 1 according to this embodiment and a battery.

The engine-driven-DC-supply unit 1 is a unit without providing mechanical power to the mobile object. In the manner described above, in the engine-driven-DC-supply unit 1 without providing mechanical traveling power to the mobile object, the engine unit 10 and the electric generator unit 20 described later are free of a driving reaction force unlike a parallel-hybrid-engine unit that provides mechanical traveling power to the mobile object. Accordingly, support rigidity of the engine unit 10 and the electric generator unit 20 can be made lower than support rigidity of the engine in the parallel-hybrid-engine unit.

In the example shown in FIG. 5, the mobile object is a vehicle V. DC power output from the engine-driven-DC-supply unit 1 is supplied to an unillustrated motor that drives wheels W of the vehicle V, as indicated by broken arrows. In the example shown in FIG. 5, front wheels and rear wheels of the vehicle V are driven by the motor using DC power output from the engine-driven-DC-supply unit 1, but only the front wheels or the rear wheels may be driven. The vehicle V may include an unillustrated battery to charge the battery with DC power output from the engine-driven-DC-supply unit 1 and drive the wheels W by the motor using electric power of the battery.

A configuration of the engine-driven-DC-supply unit 1 mountable or detachable to/from a mobile object (vehicle V) that is an example of the external load device 2 will be described below.

The base member 40 is fixed to the vehicle V. The method for fixing the base member 40 to the vehicle V may be any method such as fastening with bolts, fitting, bonding, or welding. As described above, the base member 40 is a rectangular parallelepiped frame constituted by a plurality of beam members. Accordingly, space for placing the base member 40 can be easily obtained in the mobile object, and the base member 40 can be more reliably fixed to the mobile object.

In the case of a unit including, for example, a parallel hybrid engine that provides mechanical traveling power to the mobile object, support rigidity of the engine or other members subjected to a driving reaction force needs to be increased. Accordingly, as described in this embodiment, if the unit is configured such that the elastic bodies are easily deformed around the axis of the crankshaft, the posture of the engine greatly changes by a driving reaction force so that desired functions as the unit might not be obtained. That is, the configuration of this embodiment has effects only for the engine-driven-DC-supply unit 1 that is a unit without providing mechanical traveling power to the mobile object, and is inapplicable to a unit such as the parallel hybrid engine described above.

### Second Embodiment

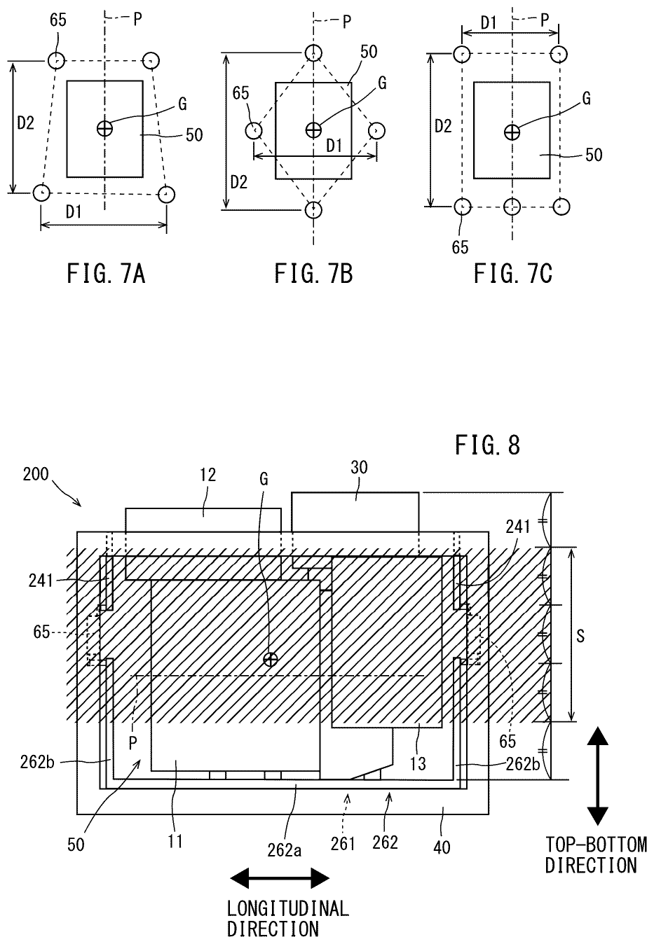

FIGS. 7A, 7B and 7C are plan views schematically illustrating layout examples of the elastic bodies 65 supporting the main component 50 of the engine-driven-DC-supply unit according to the first embodiment. For description, FIGS. 7A to 7C omit the illustration of the configuration of the engine-driven-DC-supply unit 1 except for the main component 50.

In a manner similar to the first embodiment, in this second embodiment, the main component 50 is also elastically supported to an unillustrated base member through the elastic bodies 65 at four points surrounding the barycenter G of the main component 50 in a plan view of the engine-driven-DC-supply unit 1. In a plan view of the engine-driven-DC-supply unit 1, the positions of the four points include a position at one side of the barycenter G of the main component 50 in the axial direction, a position at the other side of the barycenter G in the axial direction, a position at one side of the barycenter G in a direction orthogonal to the axial direction, and a position at the other side of the barycenter G in the direction orthogonal to the axial direction, for example.

In a plan view of the engine-driven-DC-supply unit 1, a distance D2 between the elastic body 65 at one side of the barycenter G of the main component 50 in the axial direction and the elastic body 65 at the other side is larger than a distance D1 between the elastic body 65 at one side of the barycenter G in a direction orthogonal to the axial direction and the elastic body 65 at the other side.

In a case where the plurality of elastic bodies 65 are present in the axial direction, the distance D2 between the elastic body 65 at one side of the barycenter G in the axial direction and the elastic body 65 at the other side means a maximum distance between the elastic bodies 65 located in the axial direction. In a case where the plurality of elastic bodies 65 are present in the direction orthogonal to the axial direction, the distance D1 between the elastic body 65 at one side of the barycenter G in the direction orthogonal to the axial direction and the elastic body 65 at the other side means a maximum distance between the elastic bodies 65 located in the direction orthogonal to the axial direction.

As illustrated in FIG. 7A, the elastic bodies 65 supporting the main component 50 may be arranged in a trapezoidal shape in a plan view of the engine-driven-DC-supply unit 1. That is, the distance between the elastic body 65 at one side of the barycenter G in the direction orthogonal to the axial direction and the elastic body 65 at the other side may differ between a distance between the elastic bodies 65 at one side of the barycenter G in the axial direction and a distance between the elastic bodies 65 at the other side of the barycenter G in the axial direction. The elastic bodies 65 supporting the main component 50 may be arranged in a quadrangle shape other than the trapezoidal shape or a polygonal shape in a plan view of the engine-driven-DC-supply unit 1.

As illustrated in FIG. 7B, the elastic bodies 65 supporting the main component 50 may be arranged in a rhombus shape in a plan view of the engine-driven-DC-supply unit 1. That is, the main component 50 is supported by the elastic bodies 65 at one point at each of one side and the other side of the barycenter G in the axial direction, and is supported by the elastic bodies 65 at one point at each of one side and the other side of the barycenter G in the direction orthogonal to the axial direction.

As illustrated in FIG. 7C, three elastic bodies 65 supporting the main component 50 may be located at one side of the barycenter G in the axial direction in a plan view of the engine-driven-DC-supply unit 1. Four or more elastic bodies 65 supporting the main component 50 may be located at one side of the barycenter G in the axial direction in a plan view of the engine-driven-DC-supply unit 1. Three or more elastic bodies 65 supporting the main component 50 may be located at each of one side and the other side of the barycenter G in the axial direction in a plan view of the engine-driven-DC-supply unit 1. Three or more elastic bodies 65 supporting the main component 50 may be located at one side of the barycenter G in the direction orthogonal to the axial direction in a plan view of the engine-driven-DC-supply unit 1. Three or more elastic bodies 65 supporting the main component 50 may be located at each of one side and the other side of the barycenter G in the direction orthogonal to the axial direction in a plan view of the engine-driven-DC-supply unit 1.

The configuration described above further ensures support of the main component 50 to an unillustrated base member at the four points.

### Third Embodiment

FIG. 8 is a side view illustrating a schematic configuration of an engine-driven-DC-supply unit 200 according to a third embodiment. As illustrated in FIG. 8, elastic bodies 65 are located in three regions S close to the center in the top-bottom direction in five regions obtained by equally dividing a region between the upper end and the lower end of a main component 50 in the top-bottom direction. In the following description, components similar to those of the first embodiment are denoted by the same reference characters and will not be described again, and only components different from those of the first embodiment will be described. FIG. 8 shows only a configuration of a mount member 262, but a configuration of a mount member 261 is similar to the configuration of the mount member 262. In FIG. 8, character 262a denotes a bottom, and character 262b denotes a connection portion.

As illustrated in FIG. 8, at least one of the pair of mount members 261 and 262 or supporters 241 is configured such that the elastic bodies 65 are located in the three regions S close to the center in the top-bottom direction in the five regions obtained by equally dividing the region between the upper end and the lower end of the main component 50 in the top-bottom direction when the engine-driven-DC-supply unit 200 is seen from a side.

That is, the pair of mount members 261 and 262 and the supporters 241 may have any configuration as long as the elastic bodies 65 are located in the three regions S close to the center in the top-bottom direction in the five regions obtained by equally dividing the region between the upper end and the lower end of the main component 50 in the top-bottom direction when the engine-driven-DC-supply unit 200 is seen from a side.

In FIG. 8, in the five regions obtained by equally dividing the region between the upper end and the lower end of the main component 50 in the top-bottom direction, the three regions S close to the center in the top-bottom direction are hatched. In this embodiment, it is sufficient that the elastic bodies 65 are located within the hatched region in FIG. 8.

Accordingly, since the elastic bodies 65 can be located at positions close to a barycenter G of the main component 50 in the top-bottom direction, a stroke occurring in deformation of the elastic bodies 65 can be reduced. Thus, the elastic bodies 65 can be configured to elastically deform easily. As a result, it is possible to further ensure reduction of transfer of vibrations occurring in the main component 50 to the base member 40 through the elastic bodies 65. In addition, the above-described arrangement of the elastic bodies 65 can increase layout flexibility of constituents of the main component 50.

In particular, the elastic bodies 65 are preferably located in the region at the center in the top-bottom direction in the five regions obtained by equally dividing the region between the upper end and the lower end of the main component 50 in the top-bottom direction. Accordingly, the elastic bodies 65 can be located closer to the barycenter G of the main component 50 in the top-bottom direction, and thus, transfer of vibrations from the main component 50 to the base member 40 can be effectively reduced.

### Fourth Embodiment

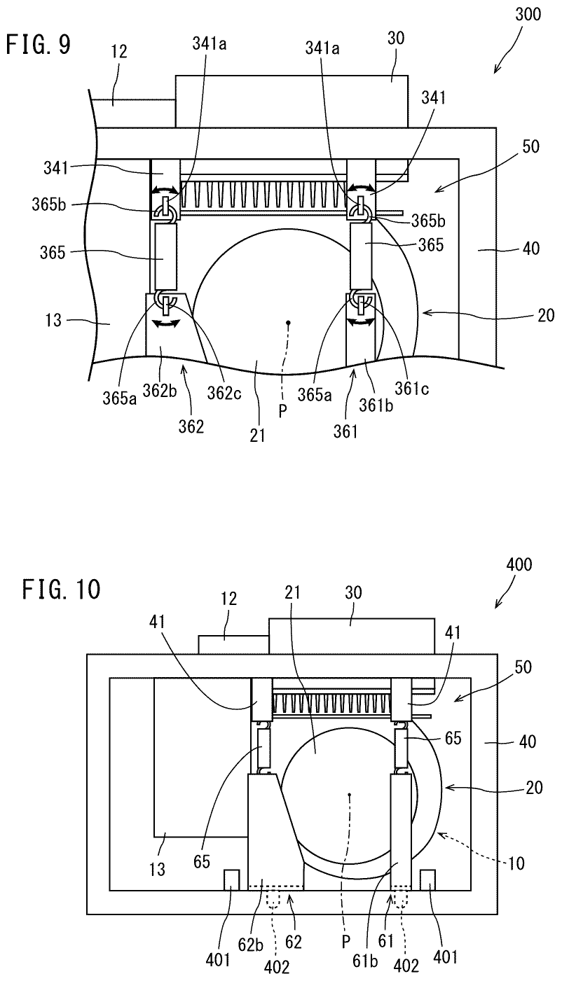

FIG. 9 is an enlarged view illustrating a connection portion where elastic bodies 365 are connected to a base member 40 and a pair of mount members 361 and 362 in an engine-driven-DC-supply unit 300 according to a fourth embodiment. As illustrated in FIG. 9, the elastic bodies 365 are different from those in the configurations of the first and third embodiments in that the elastic bodies 365 are rotatably connected to the base member 40 and the pair of mount members 361 and 362. In the following description, components similar to those of the first embodiment are denoted by the same reference characters and will not be described again, and only components different from those of the first embodiment will be described.

As illustrated in FIG. 9, each of the elastic bodies 365 includes C-shaped hook portions 365a and 365b at both ends thereof. Each of the hook portions 365a and 365b of the elastic bodies 365 has an opening that is open sideways. In this embodiment, when the engine-driven-DC-supply unit 300 is seen in the axial direction, an open direction of the opening of the hook portion 365a at one end (lower end) of each elastic body 365 is opposite to an open direction of the opening of the hook portion 365b at the other end (upper end) of the elastic body 365.

The hook portion 365a of each elastic body 365 is inserted in a hole of a ring portion 361c in a connection portion 361b of the mount member 361 or a hole of a ring portion 362c in a connection portion 362b of the mount member 362. The hook portion 365a of the elastic body 365 corresponds to a second end portion. The hook portion 365b of the elastic body 365 is inserted in a hole of a ring portion 341a in a supporter 341. The hook portion 365b of the elastic body 365 corresponds to a first end portion.

Since the hook portions 365a and 365b of the elastic bodies 365 have C shapes as described above, the hook portions 365a and 365b are rotatably connected to the ring portions 361c, 362c, and 341a. Thus, the elastic bodies 365 are rotatable to the mount members 361 and 362 or the supporters 341.

Accordingly, even in a case where the pair of mount members 361 and 362 is displaced with respect to the base member 40 in a direction other than the top-bottom direction, the elastic bodies 365 rotate with respect to the pair of mount members 361 and 362 or the base member 40 such that the force input direction coincides with the expansion and contraction direction. In this manner, even in the case where the pair of mount members 361 and 362 is displaced with respect to the base member 40 in a direction other than the top-bottom direction, deformation of the elastic bodies 365 can reduce transfer of vibrations from the pair of mount members 361 and 362 to the base member 40.

As described above, in this embodiment, the hook portions 365b of the elastic bodies 365 connected to the base member 40 are rotatably connected to the base member 40. The hook portions 365a of the elastic bodies 365 connected to the mount members 361 and 362 are rotatably connected to the mount members 361 and 362.

Accordingly, even in a case where the mount members 361 and 362 are displaced with respect to the base member 40 in a direction other than the expansion and contraction direction of the elastic bodies 365, at least one of the hook portion 365a or the hook portion 365b of each of the elastic bodies 365 rotates so that the direction of this displacement can be thereby made coincide with the expansion and contraction direction of the elastic bodies 365. Thus, even in the case where the mount members 361 and 362 are displaced with respect to the base member 40 in the direction other than the expansion and contraction direction of the elastic bodies 365 as described above, the elastic bodies 365 can be easily deformed in the expansion and contraction direction. As a result, the elastic bodies 365 can more effectively reduce transfer of vibrations of the main component 50 to the base member 40 through the pair of mount members 361 and 362.

### Fifth Embodiment

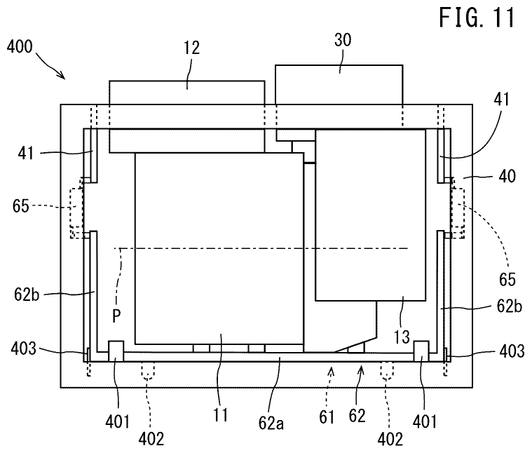

FIG. 10 is a side view of an engine-driven-DC-supply unit 400 according to a fifth embodiment when the engine-driven-DC-supply unit 400 is seen in an axial direction. FIG. 11 is a side view of the engine-driven-DC-supply unit 400 when the engine-driven-DC-supply unit 400 is seen in a direction orthogonal to the axial direction. The engine-driven-DC-supply unit 400 includes restriction portions (first restriction portions 401, second restriction portions 402, and third restriction portions 403) (stoppers) that restrict relative movement of a pair of mount members 61 and 62 to a base member 40 within a predetermined range. In the following description, components similar to those of the first embodiment are denoted by the same reference characters and will not be described again, and only components different from those of the first embodiment will be described.

As illustrated in FIGS. 10 and 11, the base member 40 includes a plurality of first restriction portions 401 that restrict a movement range of the pair of mount members 61 and 62 within a first predetermined range in a direction orthogonal to the axial direction. The first restriction portions 401 are arranged such that the pair of mount members 61 and 62 is located between the first restriction portions 401 when the engine-driven-DC-supply unit 400 is seen in the axial direction. The first predetermined range is a range where the pair of mount members 61 and 62 does not contact other constituents of the engine-driven-DC-supply unit 400 when the pair of mount members 61 and 62 is displaced with respect to the base member 40. The number of the first restriction portions 401 included in the base member 40 may be one.

The lower surfaces of bottoms 61a and 62a of the pair of mount members 61 and 62 are provided with a plurality of second restriction portions 402 that restrict a movement range of the pair of mount members 61 and 62 within a second predetermined range in the top-bottom direction. The second restriction portions 402 are located near connection portions 61b and 62b of the bottoms 61a and 62a when the engine-driven-DC-supply unit 400 is seen in a direction orthogonal to the axial direction. The second predetermined range is a range where the pair of mount members 61 and 62 does not contact the bottom surface of the base member 40 when the pair of mount members 61 and 62 is displaced with respect to the base member 40. The number of the second restriction portions 402 included in each of the pair of mount members 61 and 62 may be one.

The lower ends of the connection portions 61b and 62b of the pair of mount members 61 and 62 are provided with a plurality of third restriction portions 403 that restrict a movement range of the pair of mount members 61 and 62 within a third predetermined range in the axial direction. In the pair of mount members 61 and 62, the third restriction portions 403 project in the axial direction from the connection portions 61b and 62b located at both ends of the bottoms 61a and 62a in the axial direction. The third restriction portions 403 also project downward from the connection portions 61b and 62b. The third predetermined range is a range where the pair of mount members 61 and 62 does not contact the base member 40 in the axial direction when the pair of mount members 61 and 62 is displaced with respect to the base member 40.

The configuration of this embodiment can reduce significant displacement of the main component 50 supported by the pair of mount members 61 and 62 with respect to the base member 40 due to deformation of the elastic bodies 65 caused by vibrations of the main component 50. Thus, it is possible to reduce contact of the main component 50 with the base member 40 and displacement of the main component 50 to the outside of the base member 40.

Suppose the top-bottom direction is a Z direction and a direction orthogonal to the top-bottom direction is an X direction or a Y direction, the restriction portions may be included in the base member 40 to restrict the main component 50 in the X direction and the Y direction, restrict the main component 50 in the Y direction and the Z direction, or restrict the main component 50 in the Z direction and the X direction. In addition, the restriction portions may be included in the base member 40 to restrict the main component 50 in the X direction, the Y direction, and the Z direction.

### Other Embodiments

The embodiments of the present teaching have been described above, but the embodiments are merely examples for carrying out the present teaching. Thus, the present teaching is not limited to the embodiments described above, and the embodiments may be modified as necessary within a range not departing from the gist of the present teaching.

In the embodiments, the engine-driven-DC-supply unit 1, 200, 300, 400 includes the pair of mount members 61 and 62, 261 and 262, 361 and 362. Alternatively, the engine-driven-DC-supply unit may include only one mount member or may include three or more mount members.

In the embodiments, the engine-driven-DC-supply unit 1, 200, 300, 400 includes four elastic bodies 65, 365. Alternatively, the engine-driven-DC-supply unit may include five or more elastic bodies. In this case, it is sufficient that four of the elastic bodies are arranged in the axial direction and in a direction orthogonal to the axial direction, and the distance between the elastic bodies in the axial direction is larger than the distance between the elastic bodies in the direction orthogonal to the axial direction in a plan view.

In the embodiments, the elastic bodies 65, 365 are located between the base member 40 and the pair of mount members 61 and 62 such that the expansion and contraction direction coincides with the vertical direction. Alternatively, the elastic bodies may be located between the base member and the pair of mount members such that the expansion and contraction direction is a direction other than the vertical direction.

In the embodiments, the mount members 61, 62, 261, 262, 361, 362 are configured such that at least a part of the mount members 61, 62, 261, 262, 361, 362 is located outward of the main component 50 in a plan view and a bottom view and the elastic bodies 65, 365 are located between the upper end and the lower end of the main component 50 in the top-bottom direction. Alternatively, the mount members may be located inward of the main component in a plan view and a bottom view. The elastic bodies may be located further upward than the upper end of the main component or may be located further downward than the lower end of the main component. In the embodiments, the plurality of elastic bodies support the main component, but only one elastic member supports the main component.

In the third embodiment, the elastic bodies 65 are located within the three regions S close to the center in the top-bottom direction in the five regions obtained by equally dividing the region between the upper end and the lower end of the main component 50 in the top-bottom direction. Alternatively, the elastic bodies may be located within a region other than the three regions S close to the center in the top-bottom direction in the five regions described above.

In the fourth embodiment, the elastic bodies 365 are rotatably connected to the base member 40 and the pair of mount members 361 and 362. Alternatively, the elastic bodies may be fixed to at least one of the base member or the pair of mount members.

In the fourth embodiment, each of the elastic bodies 365 includes the C-shaped hook portions 365a and 365b, and the supporters 341 and the pair of mount members 361 and 362 include the ring portions 341a, 361c, and 362c. Alternatively, the elastic bodies may be connected to the base member and the pair of mount members in any manner as long as the elastic bodies are rotatable with respect to the base member and the pair of mount members. The elastic bodies may be rotatably connected to only one of the base member or the pair of mount members. The elastic bodies may be connected to at least one of the base member or the pair of mount members to be rotatable about the axes of the elastic bodies.

In the fifth embodiment, the base member 40 includes the first restriction portions 401 that restrict the movement range of the pair of mount members 61 and 62 within the first predetermined range in the direction orthogonal to the axial direction. Alternatively, the first restriction portions may be included in the pair of mount members. The first restriction portions may be included in the supporters fixed to the base member. The engine-driven-DC-supply unit may be free of the first restriction portions.

In the fifth embodiment, the lower surfaces of the bottoms 61a and 62a of the pair of mount members 61 and 62 are provided with the second restriction portions 402. Alternatively, the second restriction portions may be located on portions of the bottom surface of the base member located below the pair of mount members. The engine-driven-DC-supply unit may not include the second restriction portions.

In the fifth embodiment, the connection portions 61b and 62b of the pair of mount members 61 and 62 are provided with the third restriction portions 403. Alternatively, the third restriction portions may be located on portions of the base member located in the axial direction with respect to the connection portions of the pair of mount members. The engine-driven-DC-supply unit may be free of the third restriction portions.

### REFERENCE SIGNS LIST

1, 200, 300, 400 engine-driven-DC-supply unit
10 engine unit
11 engine body
12 air cleaner
13 exhaust-gas-processing device
20 electric generator unit
21 electric generator
30 controller
40 base member
41, 241,341 supporter
50 main component
61, 62, 261, 262, 361, 362 mount member
61a, 62a, 262a bottom
61b, 62b, 262b, 361b, 362b connection portion
63 top-bottom-direction supporter
65, 365 elastic body
341a, 361c, 362c ring portion
365a hook portion (second end portion)
365b hook portion (first end portion)
401 first restriction portion (stopper)
402 second restriction portion (stopper)
403 third restriction portion (stopper)
V vehicle
W wheel
P axis
S region
G barycenter
M ground
D1, D2 distance

1. An engine-driven-DC-supply unit comprising:
a base member;
a main component, including:
an engine unit including an engine body having a crankshaft,
an electric generator unit including an electric generator that is driven by the engine body, and
a controller that controls the engine unit and the electric generator unit, the main component being supported by the base member; and
a mount member and four elastic bodies, the mount member being connected to the base member and supporting the engine body and the electric generator through the four elastic bodies, wherein
the engine-driven-DC-supply unit is configured to convert electric power generated by the electric generator driven by the engine body to DC power, and to supply the converted DC power to an external load device, without providing mechanical traveling power to the external load device, and
the four elastic bodies are located at four points, where
a distance between any two of the four points located in a first direction, which is along an axis of the crankshaft of the engine body, is larger than a distance between any two of the four points located in a second direction, which is orthogonal to the first direction, and
the four points surround a barycenter of the main component in a plan view of the engine-driven-DC-supply unit.

2. The engine-driven-DC-supply unit according to claim 1, wherein in the plan view,
two of the four points are positioned at each side of the barycenter in the first direction, and
two of the four points are positioned at each side of the barycenter in the second direction.

3. The engine-driven-DC-supply unit according to claim 2, wherein
the mount member supports the engine body and the electric generator through the elastic bodies at a plurality of positions at at least one of one side or the other side of the barycenter in the first direction in the plan view.

4. The engine-driven-DC-supply unit according to claim 1, wherein
each of the elastic bodies is a metal spring.

5. The engine-driven-DC-supply unit according to claim 4, further comprising
a stopper that restricts movement of the main component with respect to the base member to within a predetermined range.

6. The engine-driven-DC-supply unit according to claim 4, wherein
each of the elastic bodies is located between the base member and the mount member, and
expansion and contraction of said each elastic body is in a vertical direction.

7. The engine-driven-DC-supply unit according to claim 6, wherein
each of the elastic bodies is a tension spring.

8. The engine-driven-DC-supply unit according to claim 1, wherein
the mount member is configured such that at least a part of the mount member is located outward of the main component in the plan view and a bottom view of the engine-driven-DC-supply unit, and
each of the elastic bodies is located between an uppermost end and a lowermost end of the main component in a top-bottom direction.

9. The engine-driven-DC-supply unit according to claim 1, wherein
each of the elastic bodies is located within three regions close to a center in the top-bottom direction in five regions obtained by equally dividing a region between the uppermost end and the lowermost end of the main component in the top-bottom direction.
